(19) United States
(12) Patent Application Publication
(10) Pub. No.: US 2013/0074981 A1
(43) Pub. Date: Mar. 28, 2013

(54) LEATHER AND VINYL RESTORATION COMPOSITION AND METHOD

(71) Applicant: Joanne Price, Milford, PA (US)

(72) Inventor: Joanne Price, Milford, PA (US)

(21) Appl. No.: 13/625,226

(22) Filed: Sep. 24, 2012

Related U.S. Application Data
(60) Provisional application No. 61/538,794, filed on Sep. 24, 2011.

(51) Int. Cl. C14C 11/00; B65B 3/04

(52) U.S. Cl. 141/9; 252/8.57

(57) ABSTRACT

This invention relates to the restoration of leather and vinyl surfaces. Specifically, this invention relates to a composition for use in maintaining and restoring leather and vinyl surfaces as well as a method of creating the composition.

### CROSS REFERENCE TO RELATED APPLICATIONS

This application claims the benefit of U.S. Provisional Patent Application No. 61/538,794 filed Sep. 24, 2011, the entire disclosure of which is incorporated herein by reference.

### FIELD OF INVENTION

This invention relates to the restoration of leather and vinyl surfaces. Specifically, this invention relates to a composition for use in maintaining and restoring leather and vinyl surfaces as well as a method of creating the composition.

### BACKGROUND OF THE INVENTION

A lengthy and complicated process turns animal skins into leather, one of the world's most durable materials. Endless uses, including luggage, clothing, upholstery and automobile interiors—to mention just a few, are all enhanced in both value and appearance by the words “Genuine Leather.” But to maintain both its beauty and durability, leather requires regular cleaning and conditioning.

Prior to World War II, leathers produced were solely vat dyed. Advantageously, vat dyed leathers are dyed through their entire thickness, but the colors available were dark and limited in number. Usually these colors faded quickly and developed into strange shades of greens or browns after exposure to the sun. Although the surfaces did not crack and chip as badly, the leather still became dry and stiff.

After the war, new technology created new demands and brighter colors quickly became popular with the availability of nitrocellulose lacquers. Leather finishes were limited in color only by imagination and taste (or lack thereof). Leathers that were vat dyed were now surface coated as well. In the early 1980's nitrocellulose lacquers gave way to the resin-base dyes in use today.

Therefore, if a vehicle predates the 1980's, then nitrocellulose lacquers were likely used in dying the leather. Nitrocellulose lacquers were brittle surface colorants generally used on the exterior metal surface of the automobile body. Flexing agents or plasticizers were added to keep them from cracking. The coloring of leather required additional plasticizers for added flexibility. There was a delicate balance which had to be maintained. Although the addition of plasticizers increased the flexibility of the lacquer, the durability decreased. The surface became more subject to wear and abrasion, and the actual adhesion of the lacquer to the leather diminished. It loosened where flexed and chipped away.

Additionally, since these colors were generally sprayed on the surface, they were further reduced with thinners for even application. The actual thickness of the lacquer finish was extremely thin. Thicker applications would create a loss of suppleness and inhibit the leather's ability to “breathe.”

Plasticizers were also unstable; they underwent a chemical change and migrated into the atmosphere—or, quite simply, disappeared. What remained on the leather surface was a stiff, brittle, non-porous coating, which in itself is bad enough. These conditions, however, further restricted the ability of the leather to flex and breathe, and actually accelerated the deterioration process. Once begun, this aging process progressed more and more rapidly. So ends the story of nitrocellulose lacquer colorants.

If old leather is not used for long periods of time, a sudden flexing will sometimes result in actual cracking like folding old, dry cardboard. Old seats have actually been known to “shatter” when pressed or sat upon.

Other things are also happening to the leather. Similarly to the plasticizers in the leather, oils that were added during the fatliquoring finishing process also migrate out of the leather. The omnidirectional fibers which were once plump and flexible are becoming thinner and more rigid. Instead of flexing and stretching with use, the fibers are getting tight and compact and tend to tear when stretched. Like bending a piece of metal repeatedly in the same place, the structure weakens and the metal breaks. This same process is happening in these “wear creases” in the color finish of leather; the leather eventually weakens in these flexed areas and separates. Instead of a surface crack, there is now an actual split in the leather. Depending on climate, storage and use, this deterioration process can happen in as little as two years.

The fiber structure of leather is omnidirectional—which simply means that it has no particular direction or pattern—like a tangled mass of spaghetti. It will stretch in all directions with no particular grain pattern or stress. The surface coating does not withstand this much abuse, however, and when leather is flexed or stretched continuously in the same spot, the surface coating develops minute cracks—not yet visible to the naked eye.

Repeated flexing and stretching eventually causes the color surface coating to chip away in certain areas and eventually the natural leather color beneath becomes visible. Usually this appears to be a crack in the leather. It is not a “crack,” though; it is merely the absence of surface colorant running in a patterned direction (wear creases).

Darker colors usually show the light color of the natural leather beneath, and light leathers do the same, except that having lost the protection of a resistant color coating, the exposed leather attracts dirt and oils and soon gets dirty and looks like a dark “crack.” Here is where the vat dyed leathers have a little advantage: the color beneath the surface coating, although usually not exactly the same color, is close enough that these creases or “cracks” are less obvious—but still unappealing.

In a frivolous little sports coupe or a favorite old army jacket or handbag, we tend to view this as “character.” When, however, furniture or an expensive automobile interior begin to show “wear” it can negatively affect the value of the item. Many times such items require reupholstering, especially when the item is a part of a meticulously restored classic automobile.

The preservation of leather can be a relatively simple matter. Keeping it clean and supple require no special abilities. Periodic cleaning with soap and water will remove most abrasive surface dirt and regular applications of beneficial oils will help to preserve its suppleness.

The most rapid deterioration of leather occurs in automobile upholstery. Subjected to freezer-to-oven-like temperature extremes, it is recommended that this leather be treated with an oil conditioner at least every three or four months. New leather should be treated after the first six months, and regularly thereafter. The flexibility and durability can be prolonged by many years with proper maintenance.

Not all conditioners are alike. In fact, one of the leading brands on the market contains about 90% water. When applied to the leather surface, it appears to “soak in” rapidly, but in fact it is the water on the surface that is evaporating leaving only a thin film of oil to benefit the leather.

Therefore, there is a need in the art for compositions for the maintenance and restoration of leather and vinyl and a method for the use of these compositions. These and other features and advantages of the present invention will be explained and will become obvious to one skilled in the art through the summary of the invention that follows.

### SUMMARY OF THE INVENTION

Accordingly, it is an object of the present invention to provide a composition and method for the maintenance and restoration of leather and vinyl.

According to an embodiment of the present invention, a composition for the maintenance and restoration of leather, the composition comprising of: an amount of acrylic polymer, forming between 3-8% of the composition, an amount of acrylic emulsion binder, forming between 5-9% of the composition, an amount of acrylic polymer emulsion, forming between 2-6% of the composition, an amount of acrylic emulsion, forming between 41-49% of the composition, an amount of defoamer, forming between 0.75-1.25% of the composition, an amount of silica flattening agent, forming between 8-12% of the composition, an amount of casein flattening agent, forming between 13-18% of the composition, an amount of finish wear enhancer, forming between 2-6% of the composition, and an amount of water based pigment dispersions, forming between 8-12% of the composition.

According to an embodiment of the present invention, the composition is a water-based polymer colorant.

According to an embodiment of the present invention, the composition is used to maintain and restore vinyl

According to an embodiment of the present invention, method of creating a restoration composition, the method comprising the steps of: creating a foam base mix, wherein the foam base mix comprises a proprietary formulation of acrylic polymer, acrylic polymer binder, acrylic polymer with hardener, acrylic emulsion with wax, and foam suppressor, combining a flatting agent to the foam base mix, wherein the flatting agent comprises a dulling agent and a rheology modifier, adding a finish wear enhancer to the foam base mix, adding pigment dispersions to the foam base mix, and packing the composition in a container, wherein the composition comprises of the foam base mix, the flatting agent, the finish wear enhancer, and the pigment dispersions.

According to an embodiment of the present invention, the dulling agent is an aqueous silicic acid mixture.

According to an embodiment of the present invention, the flatting agent is a flatting agent with a satin sheen.

According to an embodiment of the present invention, the flatting agent with a satin sheen comprises the dulling agent added at approximately 20% of the foam base mix and rheology modifier added at 10% of the dulling agent.

According to an embodiment of the present invention, the flatting agent is a flatting agent with a flat sheen.

According to an embodiment of the present invention, the flatting agent with a flat sheen comprises the dulling agent added at approximately 30% of the foam base mix and the rheology modifier added at 10% of the dulling agent.

According to an embodiment of the present invention, the pigment dispersions are 10-12% of the total of the composition.

According to an embodiment of the present invention, the container is metal.

### BRIEF DESCRIPTION OF THE DRAWINGS

FIG. 1 is a process flow of an exemplary method of producing the restoration composition.

FIG. 2 is a process flow of an exemplary method for maintaining and restoring leather.

FIG. 3 is a process flow of an exemplary method for maintaining and restoring vinyl.

### DETAILED SPECIFICATION

This invention relates to the restoration of leather and vinyl surfaces. Specifically, this invention relates to a composition for use in maintaining and restoring leather and vinyl surfaces as well as a method of creating the composition.

According to an embodiment of the present invention, a composition for the maintenance and restoration of leather and vinyl may include a flexible surface colorant. In a preferred embodiment the composition would be useful for, in addition to leather, maintaining and restoring vinyl. Unlike current lacquer based preparations which close the pores of the leather and shorten the leather's life, the composition of the present invention leaves the pores of the leather open, which keeps the leather soft, supple, and permanently flexible. Additionally, the composition will not crack, chip, or become brittle with age.

According to an embodiment of the present invention, the restoration composition allows the user to give color to both leather and vinyl. In a preferred embodiment, the restoration composition can be used to restore the color of leather or vinyl. In another preferred embodiment, the restoration composition may also be used to change the color of leather or vinyl. One of ordinary skill in the art would appreciate that there are numerous applications for embodiments of the present invention and embodiments of the present invention are contemplated for use such application.

According to an embodiment of the present invention, the restoration composition is a water based polymer dye used for refinishing leathers and vinyl. The restoration composition restores the natural leather appearance without looking painted on. This is achieved as the restoration composition does not fill in or otherwise cover up the naturally existing grain pattern of the leather or vinyl. The end result is a surface that has been renewed at a fraction of the cost of reupholstering.

According to an embodiment of the present invention, the restoration composition may be applied by a non-professional. In a preferred embodiment, the restoration composition can be applied without any specialized equipment or experience. Additionally, the restoration composition is non-toxic, low odor, and cleans up with soap and water.

According to an embodiment of the present invention, the restoration composition may be applied with a soft brush. Alternatively, the restoration composition may be applied with proper spray equipment. The restoration composition will dry to a natural finish in approximately twenty minutes. Once the restoration composition has dried, any soiling of the surface may then be cleaned with soap and water. The restoration composition will fully cure within six weeks.

According to an embodiment of the present invention, the restoration composition may be used to restore leather and vinyl surfaces. In a preferred embodiment, the composition may be used for the restoration of automobile interiors. Restoring the original interior of an automobile is usually preferred over replacing the interior and causes an increase in value of the automobile, when compared to simply replacing the interior with non-original elements. In an alternative embodiment, the composition could be used to restore any variety of vintage objects without having to replace those objects. One of ordinary skill in the art would appreciate that there are numerous restoration projects that embodiments of the present invention could be used for, and embodiments of the present invention are contemplated for use with any such restoration project.

According to an embodiment of the present invention, the restoration composition is comprised of 3%-8% acrylic polymer. Acrylic polymers include, but are not limited to, methacrylates, methyl acrylate, ethyl acrylate, 2-chloroethyl vinyl ether, 2-ethylhexyl acrylate, hydroxyethyl methacrylate, butyl acrylate, butyl methacrylate and TMPTA. One of ordinary skill in the art would appreciate that there are numerous acrylic polymers that may be used with embodiments of the present invention, and embodiments of the present invention are contemplated for use with any appropriate acrylic polymer.

According to an embodiment of the present invention, the restoration composition is comprised of 5%-9% acrylic emulsion binder. An exemplary embodiment of acrylic emulsion binders include, but are not limited to, Rockacryl RPB. One of ordinary skill in the art would appreciate that there are numerous acrylic emulsion binders that may be used with embodiments of the present invention, and embodiments of the present invention are contemplated for use with any appropriate acrylic emulsion binders.

According to an embodiment of the present invention, the restoration composition is comprised of 2%-6% acrylic polymer emulsion. One of ordinary skill in the art would appreciate that there are numerous acrylic polymer emulsions that may be used with embodiments of the present invention, and embodiments of the present invention are contemplated for use with any appropriate acrylic polymer emulsion.

According to an embodiment of the present invention, the restoration composition is comprised of 41%-49% acrylic emulsion. An exemplary embodiment of an acrylic emulsion includes, but is not limited to, Rhoplex [Rohm and Haas Co.] AC-234. One of ordinary skill in the art would appreciate that there are numerous acrylic emulsions that may be used with embodiments of the present invention, and embodiments of the present invention are contemplated for use with any appropriate acrylic emulsion.

According to an embodiment of the present invention, the restoration composition is comprised of 0.75%-1.25% defoamer. Exemplary embodiments of a defoamer include, but are not limited to, fuel oils, mineral oils, vegetable oils, silica, fatty alcohols, esters or any combination thereof. One of ordinary skill in the art would appreciate that there are numerous defoamers that may be used with embodiments of the present invention, and embodiments of the present invention are contemplated for use with any appropriate defoamer.

According to an embodiment of the present invention, the restoration composition is comprised of 8%-12% silica flattening agent. Exemplary embodiments of a silica flattening agent include, but are not limited to, white carbon black and Pyrogenic (i.e., a surface modified silica). One of ordinary skill in the art would appreciate that there are numerous silica flattening agents that may be used with embodiments of the present invention, and embodiments of the present invention are contemplated for use with any appropriate silica flattening agent.

According to an embodiment of the present invention, the restoration composition is comprised of 13%-18% casein flattening agent. One of ordinary skill in the art would appreciate that there are numerous casein flattening agents that may be used with embodiments of the present invention, and embodiments of the present invention are contemplated for use with any appropriate casein flattening agent.

According to an embodiment of the present invention, the restoration composition is comprised of 2%-6% finish wear enhancer. The finish enhancer increases the longevity of leather by reducing surface wear and provides UV protection characteristics. An exemplary embodiment of a finish wear enhancer is SLIP-AYD SL 300 POLYETHLYENE manufactured by Elementis. One of ordinary skill in the art would appreciate that there are numerous finish wear enhancers that may be used with embodiments of the present invention, and embodiments of the present invention are contemplated for use with any appropriate finish wear enhancer.

According to an embodiment of the present invention, the restoration composition is comprised of 8%-12% water based pigment dispersions. One of ordinary skill in the art would appreciate that there are numerous water based pigment dispersions that may be used with embodiments of the present invention, and embodiments of the present invention are contemplated for use with any appropriate water based pigment dispersions.

According to an embodiment of the present invention, the restoration composition is a proprietary formulation comprised of a base mix, a flatting agent, and pigment dispersions. In a preferred embodiment, the ingredients may be combined in varying ratios in order to impart a varying of properties on the restoration composition. The properties of the composition that may be varied include, but are not limited to, color and sheen. One of ordinary skill in the art would appreciate there are many variations that may be imparted onto the restoration compound by varying the ratio of the ingredients, and embodiments of the present invention are contemplated for use with any such ratio of ingredients.

According to an embodiment of the present invention, the composition is formulated by first assembling the base mix. In a preferred embodiment, the base mix is made using a proprietary formulation of acrylic polymer, acrylic polymer binder, acrylic polymer with hardener, acrylic emulsion with wax, and foam suppressor. One of ordinary skill in the art would appreciate that there are numerous compounds that could be used for each ingredient of the base mix formulation, and embodiments of the present invention are contemplated for use with any such compounds.

According to an embodiment of the present invention, a flatting agent is added to the base mix. In a preferred embodiment, the flatting agent is comprised of a dulling agent and a rheology modifier. The flatting agent can be formulated to produce a varying sheen in the finished restoration composition. In the preferred embodiment, the flatting agent may be formulated to give a satin sheen or a flat sheen. One of ordinary skill in the art would appreciate that the flatting agent may be formulated to produce a broad range of sheens, and embodiments of the present invention are contemplated for use with any such sheen.

According to an embodiment of the present invention, the flatting agent can be formulated to produce a satin sheen in the finished restoration composition. In a preferred embodiment, the flatting agent is formulated to produce a satin sheen by adding the dulling agent to the base mix at approximately 20% of the base mix and adding the rheology modifier at approximately 10% of the dulling agent.

According to an embodiment of the present invention, the flatting agent can be formulated to produce a flat sheen in the finished restoration composition. In a preferred embodiment, the flatting agent is formulated to produce a flat sheen by adding the dulling agent to the base mix at approximately 30% of the base mix and adding the rheology modifier at approximately 10% of the dulling agent.

According to an embodiment of the present invention, a finish wear enhancer is added to the mixture that includes base mix and the flatting agent.

According to an embodiment of the present invention, pigment dispersions are added to the mixture that includes the base mix, flatting agent, and finish wear enhancer. In a preferred embodiment, the pigment dispersions are added to the mixture at 10-12% of the mixture. The pigment dispersions contribute to the color of the restoration composition.

According to an embodiment of the present invention, the restoration composition has a foam consistency. In a preferred embodiment, the foam consistency prevents the restoration composition from running, therefore allowing a more consistent application of the product. This is in contrast to current products that are applied through a spray on process that makes those products susceptible to inconsistent application.

According to an embodiment of the present invention, the completed restoration composition is a water based polymer colorant. In a preferred embodiment the completed restoration composition is packaged in a small metal container.

Exemplary Methods

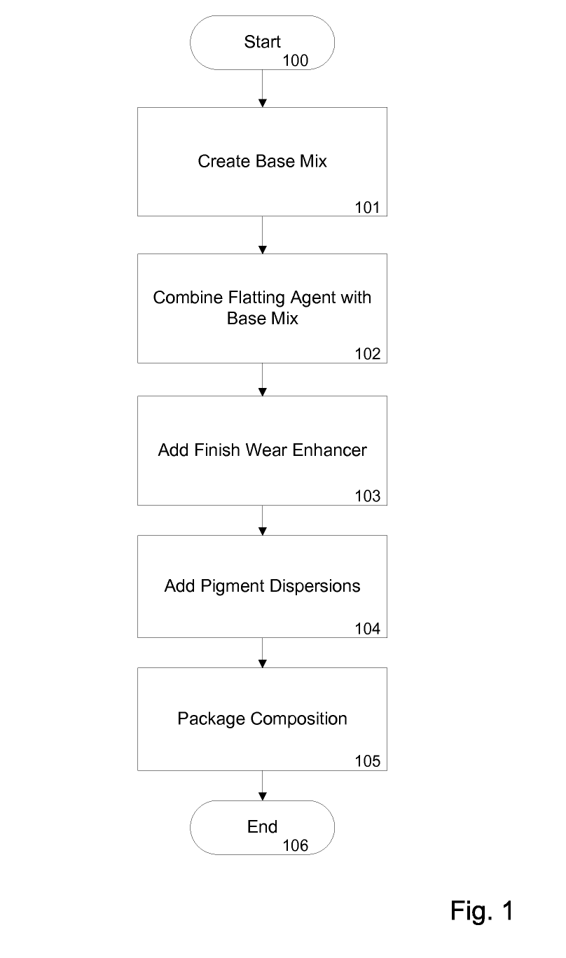

The following is an exemplary embodiment of a method for restoring leather, as shown in FIG. 1. At step 100, the process begins by gathering the components of the restoration composition.

At step 101, the base mix is created. The components of the base mix are combined according to a proprietary formula.

At step 102, a flatting agent is added to the base mix. This flatting agent can be formulated such that the restoration composition provides either a satin or a flat sheen.

At step 103, a finish wear enhancer is added. The finish wear enhancer will function as a surface protectant.

At step 104, pigment dispersions are added. The pigment dispersions give color to the restoration composition and therefore the surface it is applied to.

At step 105, the restoration composition is packaged.

At step 106, the process ends, with a finalized restoration composition that is ready for sale.

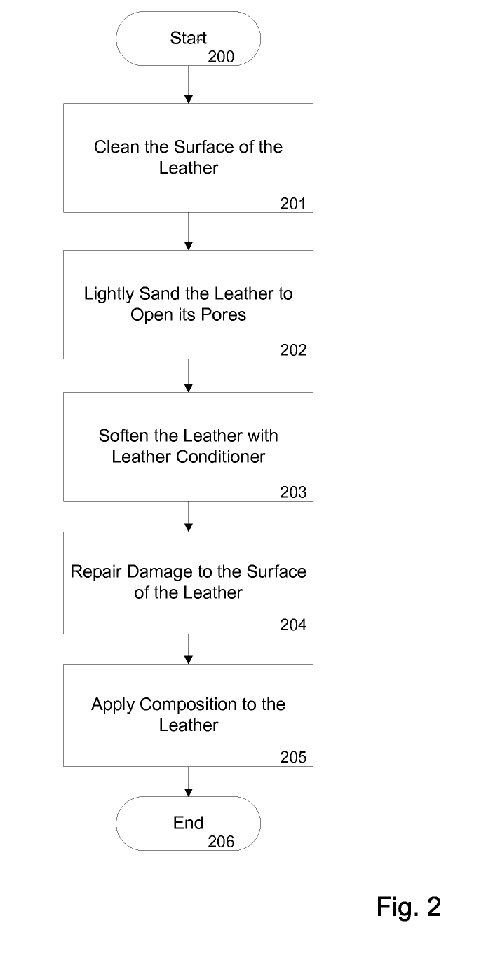

The following is an exemplary embodiment of a method for restoring leather, as shown in FIG. 2. At step 200, the leather surface is prepared for restoration.

At step 201, the surface of the leather is cleaned. The leather surface can be cleaned with any suitable solvent, including quick-dry lacquer thinner.

At step 202, the surface of the leather is lightly sanded. This process opens the pores of the leather.

At step 203, a conditioner is applied to the surface of the leather. The conditioner softens the leather surface and enhances the suppleness of the leather.

At step 204, any damage on the leather surface is repaired. The repairs to the surface of the leather might include sewing tears, patching holes, and filling cracks.

At step 205, the composition is applied to the leather. The composition returns color to the leather and improves the attractiveness of the surface.

At step 206, the composition has fully cured and the leather surface has been fully restored.

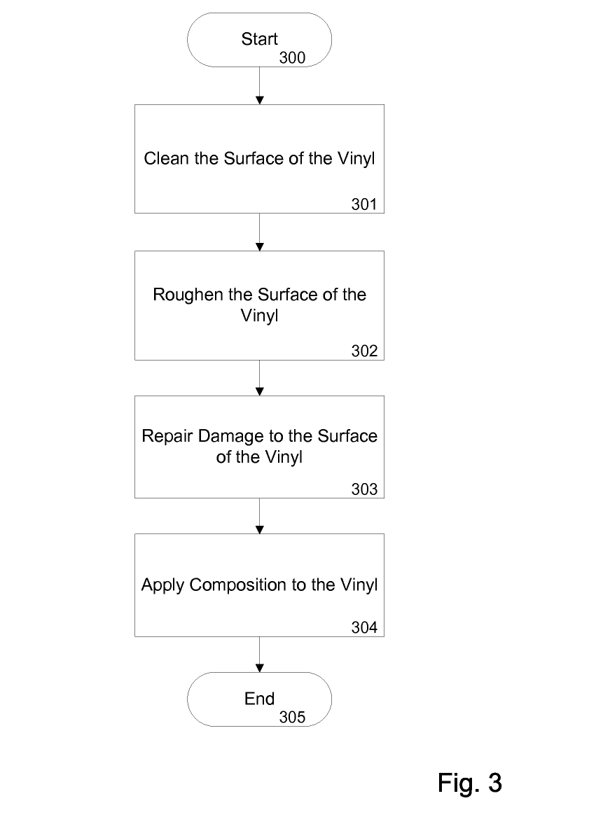

The following is an exemplary embodiment of a method for restoring leather, as shown in FIG. 3. At step 300, the vinyl surface is prepared for restoration.

At step 301, the surface of the vinyl is cleaned. The vinyl surface can be cleaned with a solution of soap and water.

At step 302, the surface of the vinyl is lightly roughened. This process ensures that the composition will properly adhere to the surface of the vinyl.

At step 303, any damage on the vinyl surface is repaired. The repairs to the surface of the vinyl might include patching holes or filling cracks.

At step 304, the composition is applied to the vinyl. The composition returns color to the vinyl and improves the attractiveness of the surface.

At step 305, the composition has fully cured and the vinyl surface has been fully restored.

Cleaning and/or Color Removal of a Leather Surface

According to an embodiment of the present invention, the user may need to remove the color coating of the leather surface that is to be restored. Brittle surface colors are responsible for at least 50% of the stiffness of old leather and removing this color coating the flexibility of the leather will be increased. In a preferred embodiment, the user may use a quick-dry lacquer thinner to remove the color coating.

The user will apply quick-dry lacquer thinner according to the manufacturer's directions, working a small area at a time. In many cases the color coating should be easily removed as it is but a thin surface coating. In addition to the lacquer thinner alone, the user may use a dull-edge object, medium-course steel wool, or anything else to help facilitate the removal of the color coating from the surface. For a particularly difficult spot, the user may use sandpaper. The user, however, should take care not to excessively roughen the surface (causing a suede appearance) or to weaken any stitching in the area that is being worked.

In some instances, not all of the color coating will come off during the cleaning and/or removal process. The surface is considered sufficiently clean when approximately 80% of the color coating has been removed. Once there is no more color coating that can be easily removed, the leather should be allowed to dry for at least 24 hours so that all of the solvents evaporate.

When the leather is dry, the user may lightly sand any rough areas and any creases that are too prominent. The creases should be sanded lightly in the direction of the crease with a piece of fine (e.g., 320 grit) sandpaper folded over the user's fingers. The user should then, very lightly and quickly, sand the entire surface. The all-over sanding opens the pores in the surface of the leather and allows it to absorb a Leather Conditioner (e.g., SOFFENER).

Conditioning and Softening Leather

According to an embodiment of the present invention, one or two coats of leather conditioner (e.g., SOFFENER) should be applied to the surface of the leather. Prior to applying the conditioner, the user should ensure the surface is clean and dry. The user may apply the conditioner to the leather with a brush. In certain instances, some areas of the leather may absorb the conditioner more rapidly than others. If this occurs, the user may apply other coats of conditioner to those areas. Once the conditioner has been applied, the use should allow the leather to absorb the conditioner for approximately 24 hours.

According to an embodiment of the present invention, the preferable temperature to apply the leather conditioner, for the best results, is at approximately 70° F. or higher. Following the application of the conditioner, the user should wait for 24 hours and then remove any residue remaining of the leather surface with a damp cloth. In a preferred embodiment, the user may use a bucket of warm water and a towel with most of the water wringed out. The user should then wipe the entire leather surface briskly to remove any oils that are on the surface. The user should then rinse the towel in the warm water and repeat the process (changing the water as necessary) until all the leather surfaces have been wiped down. As in previous steps, the leather should be allowed to dry completely, at least 24 hours, before any additional steps are started.

Making Repairs or Filling Cracks

Once the color coating has been removed, the leather surface that is being reconditioned may need to be repaired before the surface is recolored. Common examples of repairs that may need to be done are sewing damaged seams, filling in cracks, and patching holes. Having previously applied the conditioner, the user will have an easier time stretching the leather to make any repairs. The application of the conditioner also helps to ensure that further tears do not develop while the repairs are taking place.

According to an embodiment of the present invention, it may be necessary to fill in cracks of the surface that is being conditioned. While most of the cracks will be limited to the color coating and repaired simply by the removal of the color coating (as described above), there may be additional deeper cracks and creases that are in the surface of the leather or vinyl itself. The deeper cracks and creases will need to be filled in with a crack eliminator (e.g., FLEX-FILL Crack Eliminator). The crack eliminator should be sparingly applied, to cracked or creased areas only, and allowed to dry. When thoroughly dry, the area should be sanded smooth with fine (320 grit) sandpaper. The user may then continue the restoration process with the application of the composition.

According to an embodiment of the present invention, it may be necessary to patch the leather or vinyl surface that is being reconditioned. In cases where the surface is split or where a crack is deep and appears as though it will split through eventually, it is best to reinforce this damaged area with a patch from behind. The easiest way to accomplish the repair is to remove the covering from the object and glue a piece of leather, vinyl, or canvas to the back with a quality adhesive (e.g. contact cement) that is compatible with the materials being bonded.

If the covering of the object is not removable, the crack may then be slit with a cutting device (e.g., razor blade) to create flaps. Next, a piece of reinforcing material can be worked beneath the leather or vinyl and centered beneath the newly made opening. Once the reinforcing material has been placed, adhesive should be applied to the reinforcing material and the flaps should be folded back down to create a bond with the reinforcing material. The damaged area should be held closed (e.g. with tape) as best as possible and allowed dry. Once dry, the user may apply a crack eliminator in the resulting “scar” and when dry, sand smooth. If the cut is deep enough, it might require a few layers of crack eliminator to build up the surface before sanding.

Recoloring the Leather

According to an embodiment of the present invention, a leather surface may be recolored as a part of the restoration process. Before the composition that will recolor the leather is applied, it is important for the user to ensure that the leather is absolutely dry. A dry surface is important to ensure that the composition will penetrate the leather and form a durable bond. A damp surface will prevent the composition from adhering properly and detract from the quality of the restoration.

According to an embodiment of the present invention, the leather surface may require a final wipe down before applying the composition. In a preferred embodiment, the leather surface may be quickly wiped down with a cloth dampened with quick-dry lacquer thinner. The leather should not be saturated, as this step is meant to only remove any residue that remains from the conditioning and repair steps above. As in previous steps, the leather should be allowed to dry for at least 24 hours.

Application of Composition

According to an embodiment of the present invention, the composition may be applied with a clean, soft-bristle brush. In order get a feel for the process and develop a good technique, the user may wish to apply the composition to an inconspicuous area, such as the back of a seat or cushion, first. The user should only apply a thin first coat and not attempt to achieve good color coverage. Rebrushing of dry areas should be avoided to help eliminate brush marks. Brush marks can also be reduced by varying the pattern of application (use crosshatch strokes or short half-circles).

According to an embodiment of the present invention, a second coat of the composition may be applied after the first coat has dried to the touch (approximately 15-20 minutes). This second light coat will give excellent color coverage and will result in a minimal amount of surface colorant. Using minimal surface colorant will avoid the “painted” look that many solvent-base dyes leave. When necessary, the user may apply a third coat or touch up spots where the color seems to be uneven. The user should be aware that the color may change when dry and the subsequent coats will appear to be a different shade. These variations, however, will all blend when completed.

According to an embodiment of the present invention, the composition may be applied with a spraying apparatus. In a preferred embodiment, the user should choose a narrow “fan” pattern and an air pressure of about 25 p.s.i. The user should apply a full wet coat first to allow for penetration into the leather. The user should then apply subsequent coats that are lighter, which will help ensure good color coverage. The user should take care to avoid the application of a “dry” first coat. A “dry” first coat will create a “bridging” effect where the composition, instead of penetrating into the leather, dries on the surface in a thin film, increasing the likelihood that the coating might crack or peel.

According to an embodiment of the present invention, a user may choose a composition that is red in color. It should be noted that if spraying a red color, the user will need to spray a first coat “dry,” and build up color coverage with subsequent dry coats. This is because most bright red colors are more viscous than other colors and may require more coats for complete color coverage.

According to an embodiment of the present invention, the composition may be applied with a “wipe” technique. In a preferred embodiment, the user may wipe the composition over the surface of the leather with cheesecloth or a terry type cloth. This application uses friction to work the composition into the surface of the leather. When utilizing this method, it is important for the user to note that if additional coats are required, it is advisable to spray the subsequent coats.

Finishing and Curing

According to an embodiment of the present invention, a user should buff the leather surface once the composition has thoroughly dried. In a preferred embodiment, the user may use a soft, dry cloth to lightly buff the leather. This process removes any surface pigment and helps to bring out the natural low-luster sheen of a new leather finish. To enhance the sheen of the leather, the composition contains a special wax that buffs up to help resist dirt.

According to an embodiment of the present invention, the composition dries completely in about 20 minutes. The composition dries to the touch in approximately 20 minutes and is durable enough to be used in approximately 24 hours. Complete curing of the composition is achieved in about 6 weeks. After the composition has completely cured, it can be cleaned with some and water and cared for as any other durable surface.

According to an embodiment of the present invention, any newly colored surface is not immediately penetrable. As a result, there is no need to condition the leather surface in the first six months following the application of the composition. After this time, however, the leather surface should be conditioned every three to four months. In a preferred embodiment, the user may use a leather conditioner such as SOFFNER Quick Formula. When conditioning the leather, a user should take particular care to treat perforated and stitched areas.

Refinishing Vinyl

According to an embodiment of present invention, the composition may be used to restore vinyl surfaces. Unlike leather, which is a natural organic product, vinyl and other imitations are of chemical composition. Impregnated with plasticizers, they generally remain supple for quite a long time. When the plasticizers eventually migrate into the atmosphere, there is nothing that can be done to re-soften these materials. Surface blemishes such as rips or tears and holes can be repaired in the same manner as with leather, and they can be refinished. In order to achieve the best results, a user should recolor a vinyl surface in the same color as the original finish.

According to an embodiment of present invention, a user may clean the vinyl surface in order to prepare the surface for refinishing. In a preferred embodiment, it is recommended that a cleaner (e.g., Color Plus's SUPER CLEANER) be used to clean the vinyl surface before applying the composition. Additionally, it is recommended that the surface is thoroughly washed and rinsed with soap and water, prior to application of the composition. The user should let the surface dry thoroughly before proceeding with the coloring. It is important for the user to note that the use of lacquer thinner or any strong solvent to clean vinyl IS NOT recommended. These cleaners have a tendency to dissolve or “melt” the vinyl surface, leaving it sticky and unworkable.

After the vinyl surface is clean and dry, the user should sand it lightly with either very fine sandpaper or steel wool. After sanding, the user should take care to remove all residue from the surface with a Tack Cloth or similar product. Due to the nonporous nature of vinyl, it is imperative that no residue is left on the surface when applying the composition. Once prepared in this manner, the recoloring procedure is the same as for leather.

According to an embodiment of the present invention, the composition may be applied with a spraying apparatus. In a preferred embodiment, the user should choose a narrow “fan” pattern and an air pressure of about 25 p.s.i. Additionally, the user should apply a full wet first coat, taking care to avoid runs or puddles. After the initial coat has dried and where necessary, the user may apply subsequent coat(s) to ensure good color coverage. As with the leather treatment, the composition dries for use within 24 hours and cures completely in about 6 weeks, after which time the new composition finished surface can be cleaned with soap and water or cleaning preparations intended for such use.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A composition for the maintenance and restoration of leather, said composition comprising of:
an amount of acrylic polymer, forming between 3-8% of said composition;
an amount of acrylic emulsion binder, forming between 5-9% of said composition;
an amount of acrylic polymer emulsion, forming between 2-6% of said composition;
an amount of acrylic emulsion, forming between 41-49% of said composition;
an amount of defoamer, forming between 0.75-1.25% of said composition;
an amount of silica flattening agent, forming between 8-12% of said composition;
an amount of casein flattening agent, forming between 13-18% of said composition;
an amount of finish wear enhancer, forming between 2-6% of said composition;
and an amount of water based pigment dispersions, forming between 8-12% of said composition.

2. The composition of claim 1, wherein said composition is a water-based polymer colorant.

3. The composition of claim 1, wherein said composition is used to maintain and restore vinyl.

4. A method of creating a restoration composition, said method comprising the steps of:
creating a foam base mix, wherein said foam base mix comprises a proprietary formulation of acrylic polymer, acrylic polymer binder, acrylic polymer with hardener, acrylic emulsion with wax, and foam suppressor;
combining a flatting agent to said foam base mix, wherein said flatting agent comprises a dulling agent and a rheology modifier;
adding a finish wear enhancer to said foam base mix;
adding pigment dispersions to said foam base mix; and
packing said restoration composition in a container, wherein said composition comprises of said foam base mix, said flatting agent, said finish wear enhancer, and said pigment dispersions.

5. The method of claim 4, wherein said dulling agent is an aqueous silicic acid mixture.

6. The method of claim 4, wherein said flatting agent is a flatting agent with a satin sheen.

7. The method of claim 6, wherein said flatting agent with a satin sheen comprises said dulling agent added at approximately 20% of said foam base mix and said rheology modifier added at 10% of said dulling agent.

8. The method of claim 4, wherein said flatting agent is a flatting agent with a flat sheen.

9. The method of claim 8, wherein said flatting agent with a flat sheen comprises said dulling agent added at approximately 30% of said foam base mix and said rheology modifier added at 10% of said dulling agent.

10. The method of claim 4, wherein said pigment dispersions are 10-12% of the total of said composition.

11. The method of claim 4, wherein said container is metal.
